(19) United States
(12) Patent Application Publication
(10) Pub. No.: US 2026/0200062 A1
(43) Pub. Date: Jul. 16, 2026

(54) Utility Tool for Truck

(71) Applicant: YuanGang Ding, Rancho Cucamonga, CA (US)

(72) Inventor: YuanGang Ding, Rancho Cucamonga, CA (US)

(21) Appl. No.: 19/015,966

(22) Filed: Jan. 10, 2025

(51) Int. Cl. B25F 1/00; A62B 3/00; B25G 1/04; B25G 1/10

(52) U.S. Cl. CPC B25F 1/006; A62B 3/005; B25G 1/04; B25G 1/102

(57) ABSTRACT

A utility tool for truck includes a thumper head having a hammer portion and a glass breaker portion and a retractor joint assembly configured to rigidly and securely connect a tubular handle and a solid bar in an extendable and retractable manner to form a handle bar. When the solid bar is extended form the tubular handle, the utility tool is capable of functioning as a fifth wheel pin puller. When the solid bar is retracted in the tubular handle, the solid bar is ensured to be coaxially received in a receiving channel of the tubular handle in a rigid and firm manner to form an ergonomic handle while the utility tool is used as a tire thumper with the hammer portion and a glass breaker with the glass breaker portion of the thumper head.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a fifth wheel pin puller, and more particularly to a utility tool configured to not only use as a fifth wheel pin puller, but also provide multiple functions specifically designed for the truck driver.

### Description of Related Arts

To a truck driver, multiple tools are needed to carry for each transportation trip, including a fifth wheel pin puller, a tire thumper and a glass breaker for emergency.

FIG. 1 illustrates a conventional fifth wheel pin puller which is used to help the truck drivers safely and easily release the locking pin (or handle) on the fifth wheel coupling, which connects a tractor (truck) to a trailer (container). A typical pin puller should be designed to provide extra leverage with a long handle offering leverage, making it easier to pull the locking pin without using excessive force, especially when the pin is tight or difficult to release, and enhance safety by allowing the driver to stand at a safe distance from the fifth wheel to reduce the risk of injury while keeping the driver out of the direct path of the trailer and away from the pinch points where the fifth wheel might move or release suddenly.

In order to achieve the above purposes, the fifth wheel pin puller is typically configured to have an integral and elongated metal bar as long as 32 inches. Although most truck drivers would like to store the pin puller in the cab such as under the seat or in a dedicated storage space, the elongated length of the pin puller is generally kept in the side compartment mounted on the chassis located under the cab or along truck frame or secured on the deck area behind the cab.

As shown in FIG. 1, the conventional fifth wheel pin puller comprises a handle P1, which is an elongated sturdy rod, preferably made of metal or reinforced plastic, a hooked or curved end member P2 integrally formed at one end of the handle P1 and configured to latch onto the locking pin of the fifth wheel, and a grip bar P3 perpendicularly and integrally connected to another end of the handle P1 for the driver to hand grip thereon.

However, such round shaped grip bar P3 is not designed ergonomics. That requires the driver's hand to grip tightly with much finger pressure in order to firmly hold on the grip P2 to prevent slipping that may cause injury to the driver's wrist and fingers.

Further, the tire pressure is the key safety factor to the truck driver because properly inflated tires not only improve truck stability, handling and braking but also prevents uneven wear and reduces operational costs. Tires with lower pressure create more rolling resistance rendering the truck engine has to work harder, increasing fuel consumption. It is more important that trucks carry heavy loads and each tire supports a portion of that weight. Underinflated tires can't bear weight as effectively that risks tire failure, especially during long hauls or with full loads. Therefore, the truck driver is required to check the tire pressure with a tire thumper from time to time for routine inspection during a transportation trip to reduce the risk of blowouts or flat tires that especially can be dangerous at high speeds to the truck itself and other vehicles on the road.

FIG. 2 illustrates a conventional tire thumper that the truck drivers carry for gauging if the tire is underinflated based on the sound and feel of the impact by hitting the tire, wherein properly inflated tires produce a solid, resonant sound, while underinflated tires would sound dull and feel softer upon impact. Although any object such as a bar or a bat can be used to hit the tire, a hammer type thumper is preferred to provide efficient and effective solid hitting on the tire.

To drivers of all kinds of vehicle, a glass breaker is a safety tool to be carrier in the cab interior to help the drivers to escape quickly from their vehicle or to help others encountering accidents in emergency situations.

### SUMMARY OF THE PRESENT INVENTION

The invention is advantageous in that it provides a utility tool for truck which can be used as a fifth wheel pin puller, a tire thumper and a glass breaker.

Another advantage of the invention is to provide a utility tool for truck which handle bar is configured retractable in such manner that when the handle bar is in the extended state, the handle bar is rigidly extended its length to form a fifth wheel pin puller, and when the handle bar is the retract state, the length of the handle bar is reduced to form a handle with solid bar for the truck driver to hold by hand to use the utility tool as a tire thumper and glass breaker.

Another advantage of the invention is to provide a utility tool for truck which handle bar has a distal end configured to form a hook r and a proximal end rigidly and firmly connected with a thumper head perpendicularly which is configured and shaped to be gripped by hand when the handle bar is extended out coaxially to the extended state to function as the fifth wheel pin puller.

Another advantage of the invention is to provide a utility tool for truck which thumper head has a hammer portion configured to function as a hammer and a glass breaker portion configured to function as a glass breaker, such that when the handle bar is retracted to the retract state, the driver can hand hold the handle bar and use the thumper head as a tire thumper with the first portion and a glass breaker with the second portion.

Another advantage of the invention is to provide a utility tool for truck which thumper head is configured both functionally and ergonomically, ensuring the driver can use the thumper head comfortably as a grip handle while the handle bar is extended to be used as a fifth wheel pin puller without excessive strain on the hand and fingers of the driver.

Another advantage of the invention is to provide a utility tool for truck, wherein the larger hammer portion of the thumper head is adapted to fit comfortably between the thumb and index finger of the driver's hand, and the glass breaker portion of the thumper head, which is the tapered, circular portion extended from the hammer portion to an opposite end, is adapted to suit the middle, ring and pinky fingers of the driver's hand to wrap around comfortably. The larger surface area and the indented groove provided around the hammer portion of the thumper head provide a stable grip area, allowing the driver to exert control without excessive pressure, that minimizes strain on the fingers and helps the driver to maintain a firm hold, especially when pulling the locking pin of the fifth wheel. The tapered shape of the glass breaker of the thumper head is suited for the middle, ring and pinky fingers to wrap around comfortably, adapting to the natural grip curvature of the driver's hand, allowing for a secure grip with minimal effort, and reducing the risk of slipping while providing a reliable point for exerting force and the entire hand of the driver fittingly grip on the thumper head without clearance.

Another advantage of the invention is to provide a utility tool for truck which provides a retractor joint assembly configured to ensure a rigid and secure connection between a tubular handle and a solid bar in an extendable and retractable manner, allowing the handle bar in the extend state functioning as a fifth wheel pin puller to have a rigid and elongated long handle to provide extra leverage for ease to pull the locking pin effectively.

Another advantage of the invention is to provide a utility tool for truck which provides a retractor joint assembly configured to ensure a rigid and secure connection between a tubular handle and a solid bar, wherein in the retract state, the solid bar is ensured to be coaxially received in the tubular handle in a rigid and firm manner, so that the handle bar becomes a solid body and has a relatively heavier weight, facilitating the driver to securely hand hold and control the impact operation of the thumper head as the tire thumper and the glass breaker.

Another advantage of the invention is to provide a utility tool for truck, wherein the retractor joint assembly further has an air channel formed in the sliding stud, extending from an end opening of the air channel, formed at an end of the sliding stud, to at least one second side opening of the air channel, formed at a side surface of the sliding stud while the sealing ring is mounted on the outer surface of the sliding stud and positioned between the end opening and the at least one second side opening, such that the sliding stud of the retractor joint assembly is capable of smoothly sliding along the receiving channel in an air-tight manner and divides the receiving channel into a first section between the sliding stud and the thumper head and a second section between the sliding stud and the joint head, wherein the first section and the second section of the receiving channel are sealingly isolated by the sealing ring mounted on the sliding stud and communicating through the air channel. Accordingly, when the sliding stud slides towards the thumper head, the air in the first section of the receiving channel flows into the second section of the receiving channel via the air channel, and when the sliding stud slides towards the joint head, the air in the second section of the receiving channel flows into the first section of the receiving channel via the air channel.

Another advantage of the invention is to provide a utility tool for truck which is configured to be magnetically attached to a magnetically attractable surface, allowing the driver to keep the utility tool in place in a firm and stable manner without any additional docket holster, storage container or mounting catch or clip.

Additional advantages and features of the invention will become apparent from the description which follows, and may be realized by means of the instrumentalities and combinations particular point out in the appended claims.

According to the present invention, the foregoing and other objects and advantages are attained by a utility tool for truck, comprising:
a handle bar comprising a tubular handle having an axial circular receiving channel defined therein and an elongated solid bar having a length longer than that of the tubular handle and a diameter slightly smaller than a diameter of the receiving channel;
a hook element integrally provided at a distal end of the solid bar of the handle bar;
a thumper head comprising a hammer portion configured to function as a hammer and a glass breaker portion configured to function as a glass breaker, wherein a proximal end of the tubular handle of the handle bar is firmly and securely connected to a position between the hammer portion and the glass breaker portion such that the handle bar is perpendicularly extended from the thumper head; and
a retractor joint assembly configured to rigidly and securely connect the tubular handle and the solid bar in an extendable and retractable manner, wherein when the solid bar is extended form the tubular handle of the handle bar in an extend state, the utility tool is capable of functioning as a fifth wheel pin puller, and that when the elongated solid bar is retracted in the tubular handle in a retract state, the solid bar is ensured to be coaxially received in the receiving channel in a rigid and firm manner to form a handle while the utility tool is used as a tire thumper with the hammer portion and a glass breaker with the glass breaker portion of the thumper head.

In one embodiment, the proximal end of the tubular handle of the handle bar of the utility tool is fittingly inserted into a mounting socket perpendicularly formed in a middle connection portion of the thumper head in a rigid and firm manner so as to integrally connected the tubular handle of the handle bar with the thumper head in a perpendicular manner, such that the hammer portion and the glass breaker portion of the thumper head are extended at two opposing sides of the tubular handle, wherein the middle connection portion is approximately a center of gravity of the thumper head.

In one embodiment, the utility tool further comprises a magnetic member inserted into a bottom end of a mounting socket perpendicularly formed in the thumper head. Then the proximal end of the tubular handle is fittingly inserted into the mounting socket until pressing against the magnetic member in a rigid and firm manner, such that the tubular handle of the handle bar is integrally connected with the thumper head in a perpendicular manner, such that the hammer portion and the glass breaker portion of the thumper head are extended at two opposing sides of the tubular handle, and the thumper head is configured to be a magnetic attractable body that allows the utility tool to attach on any metallic surface by magnetically attracting the middle connection portion thumper head to the metallic surface.

In one embodiment, the retractor joint assembly comprises a connector member having a through hole having a diameter equal to or slightly larger than an outer diameter of the solid bar, a sliding stud having a predetermined axial length and an outer diameter equal to or slight smaller than an inner diameter of the tubular handle, and first and second sealing rings. The connector member comprises a joint head having an outer diameter equals to an outer diameter of the tubular handle and a threaded connector integrally extended from the joint head and configured to be screwingly connected to an inner enlarged threaded slot provided at a distal end of the tubular handle. The sliding stud is integrally connected, such as screwing, to a connecting end of the solid bar coaxially after the solid bar penetrates through the through hole of the connector member 41. The first sealing ring is mounted to an inner surface of the joint head so that the solid bar penetrating through the through hole of the connector member can be sealingly and smoothly sliding therebetween coaxially and the second sealing ring is mounted to an outer surface of the sliding stud so that the sliding stud can be sealing and smoothly sliding along the tubular handle coaxially.

In one embodiment, the length of the connector member is preferred to be at least equal to the diameter of the tubular handle and the length of the sliding stud is preferred to be double greater than the diameter of the tubular handle, such that when the solid bar is fully extended from the tubular handle in the extend state, the solid bar is maintained coaxially with the tubular handle due to a flexural resistance provided by an overlapping length equal to a total length of the connector member and the sliding stud.

In one embodiment, the retractor joint assembly further has a T-shape air channel formed in the sliding stud, extending from an end opening of the air channel, coaxially formed at an end of the sliding stud, to two second side openings of the air channel, radially formed at two opposing side surfaces of the sliding stud while the sealing ring is mounted on the outer surface of the sliding stud and positioned between the end opening and the two second side openings, such that the sliding stud of the retractor joint assembly is capable of smoothly sliding along the receiving channel in an air-tight manner and divides the receiving channel into a first section between the sliding stud and the thumper head and a second section between the sliding stud and the joint head, wherein the first section and the second section of the receiving channel are sealingly isolated by the sealing ring mounted on the sliding stud and communicating through the air channel. Thereby, when the sliding stud slides towards the thumper head, the air in the first section of the receiving channel flows into the second section of the receiving channel via the air channel, and when the sliding stud slides towards the joint head, the air in the second section of the receiving channel flows into the first section of the receiving channel via the air channel.

In one embodiment, a distal end of the sliding stud has embedded a magnetic attractable element so that when the solid bar is fully retracted in the tubular handle, the magnetic attractable element is attached to the magnetic member to retain the retract state of the handle bar, preventing the solid bar from sliding out during the impact action of the utility tool while it is used as a tire thumper and glass breaker, unless a pulling force is applied by the driver to pull the solid bar out of the tubular handle.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a conventional fifth wheel pin puller.

FIG. 2 is a perspective view of a conventional tire thumper.

FIG. 3 is a perspective view of a utility tool for truck in retract state according to a preferred embodiment of the present invention.

FIG. 4 is a perspective view of the utility tool for truck in extend state according to the above preferred embodiment of the present invention.

FIG. 5 is an exploded view of the utility tool for truck according to the above preferred embodiment of the present invention.

FIG. 6 is an exploded view of the retractor joint assembly of the utility tool for truck according to the above preferred embodiment of the present invention.

FIG. 7 is a partial sectional view of the thumper head of utility tool for truck according to the above preferred embodiment of the present invention.

FIG. 8 is a partial sectional view of the retractor joint assembly of the utility tool for truck in extend state according to the above preferred embodiment of the present invention.

FIG. 9 is a partial sectional view of the handle bar of the utility tool for truck according to the above preferred embodiment of the present invention.

FIG. 10 is a schematic view illustrating the alignment of the axises of the utility tool and the hand of the driver according to the above preferred embodiment of the present invention.

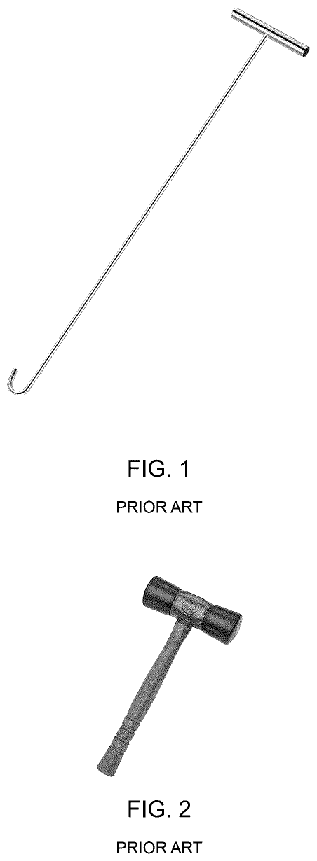

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In addition, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

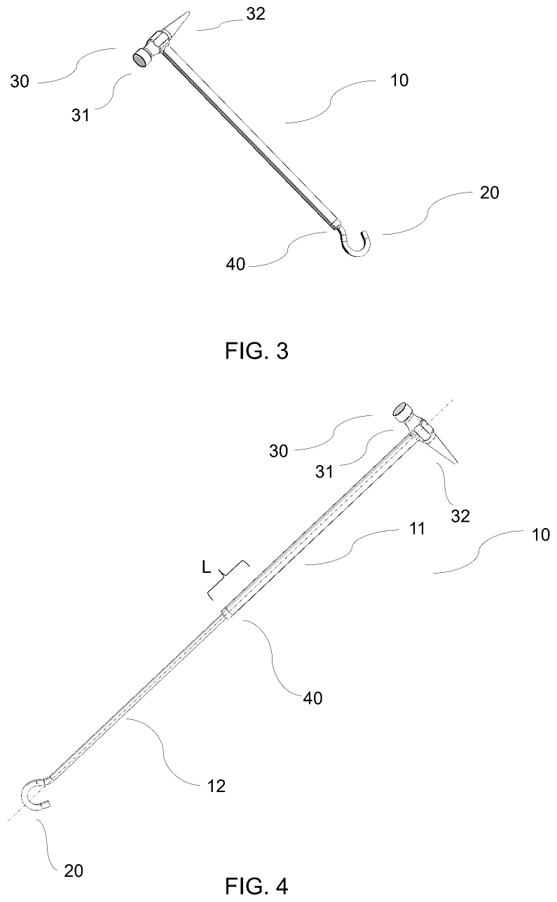

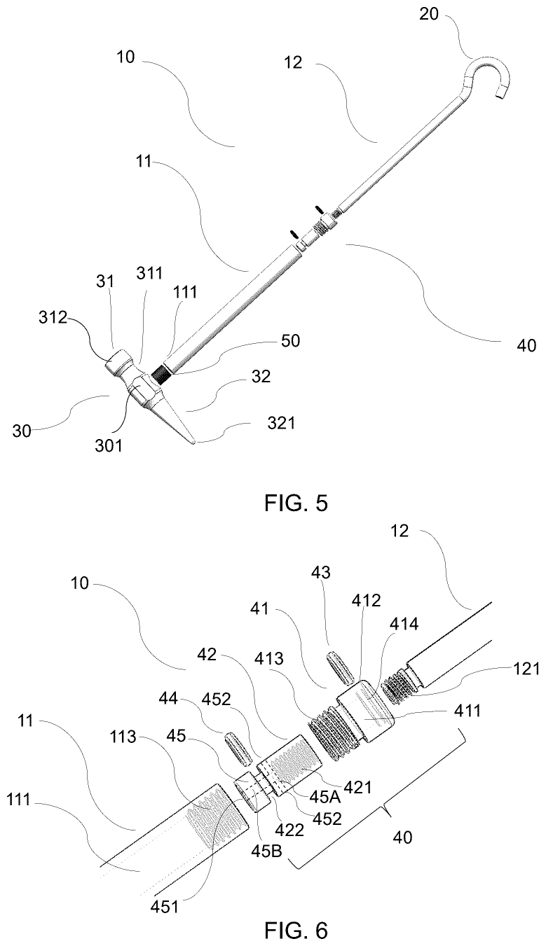

Referring to FIG. 3 to FIG. 9, a utility tool for truck according to a preferred embodiment of the present invention is illustrated. The utility tool comprises a handle bar 10, a hook element 20, a thumper head 30, and a retractor joint assembly 40.

The handle bar 10 comprises a tubular handle 11 having an axial circular receiving channel 111 defined therein and an elongated solid bar 12 having a length longer than that of the tubular handle 11 and a diameter slightly smaller than a diameter of the receiving channel 111. The hook element 20 is integrally provided at a distal end of the solid bar 12 of the handle bar 10.

The thumper head 30 comprises a hammer portion 31 configured to function as a hammer and a glass breaker portion 32 configured to function as a glass breaker, wherein a proximal end of the tubular handle 11 of the handle bar 10 is firmly and securely connected to a position between the hammer portion 31 and the glass breaker portion 32 such that the handle bar 10 is perpendicularly extended from the thumper head 30.

According to the preferred embodiment, the tubular handle 11 and the solid bar 12 of the handle bar 10, the hook element 20 and the thumper head 30 are made of stainless steel.

The retractor joint assembly 40 is configured to rigidly and securely connect the tubular handle 11 and the solid bar 12 in an extendable and retractable manner, wherein when the elongated solid bar 12 is extended form the tubular handle 11 of the handle bar 10 in an extend state, the utility tool is capable of functioning as a fifth wheel pin puller, as shown in FIG. 4, and that when the elongated solid bar 12 is retracted in the tubular handle 11, the solid bar 12 is ensured to be coaxially received in the receiving channel 111 in a rigid and firm manner to form a handle while the utility tool is used as a tire thumper with the hammer portion 31 and a glass breaker with the glass breaker portion 32 of the thumper head 30, as shown in FIG. 3.

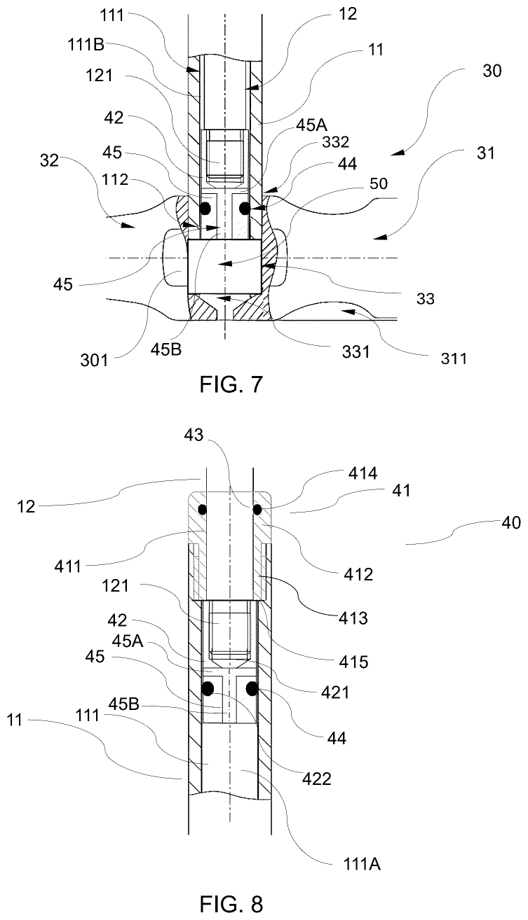

According to the preferred embodiment, as shown in FIG. 7, a middle connection portion 301, between the hammer portion 31 and the glass breaker portion 32, of the thumper head 30 has a mounting socket 33 perpendicularly formed therein, wherein the mounting socket 33 has a diameter equal to or slightly smaller than an outer diameter of the tubular handle 11, such that a proximal end of the tubular handle 11 of the handle bar 10 is fittingly inserted into the mounting socket 33 in a rigid and firm manner so as to integrally connected the tubular handle 11 of the handle bar 10 with the thumper head 30 in a perpendicular manner. The hammer portion 31 and the glass breaker portion 32 of the thumper head 30 are extended at two opposing sides of the tubular handle 11.

The glass breaker portion 32 is configured to have a taper shape, such as a conical shape, reducing a size gradually from the middle connection portion to a free end to form a breaker point 321 adapted for impacting onto a glass surface to break the glass, such as the windshield or window of the truck.

The hammer portion 31 of the thumper head 30 has a ring groove 311 circularly indented between a front end portion 312 thereof and the middle connection portion 301, wherein the ring groove 311 has curvature configured to generally match a curvature of the index finger of an adult for guiding the driver's hand to properly hold on the thumper head 30 in a balance and effective manner through allowing the index finger of the hand of the driver who grips on the thumper head 30 to place fittingly therein to ensure a firm grip and avoid slipping of the finger. The formation of the ring groove 311 also reduces the weight of the hammer portion 31 to, preferably, be equal to the weight of the glass breaker portion 32, so that the middle connection portion 301 is approximately a center of gravity of the thumper head 30.

According to the preferred embodiment, the middle connection portion 301 of the thumper head 30 has a mounting socket 33 which is a perpendicular hole having a bottom end 331 and an open end 332 at a bottom side of the middle connection portion 301 of the thumper head 30. The utility tool further comprises a magnetic member 50, having a diameter equal to the diameter of the mounting socket 33, fittingly inserted in the mounting socket 33 via the open end until one end of the magnetic member 50 pressing against the bottom end 331 of the mounting socket 33. Then, a proximal end portion 112 of the tubular handle 11 is fittingly inserted into the mounting socket 33 until pressing against the magnetic member 50 in a rigid and firm manner, such that the magnetic member 50 is securely engaged in the thumper head 30 and the tubular handle 11 of the handle bar 10 is integrally connected with the thumper head 30 in a perpendicular manner, wherein the hammer portion 32 and the glass breaker portion 31 of the thumper head 30 are extended at two opposing sides of the tubular handle 10. Accordingly, the thumper head 30 is configured to be a magnetic attractable body that allows the utility tool to attach on any metallic surface by magnetically attracting the middle connection portion 301 of the thumper head 30 to the metallic surface for storage purpose when the utility tool is not used without the need of any docking station or additional clip and holster. The magnetic ability of the utility tool also allows the driver to temporarily attract to a metal surface such as the container wall or frame while, for example, locating the locking pin while using it as a fifth wheel pin puller or fixing a tire while using it as a tire thumper.

In particular, adhesive can be applied between the magnetic member 33, the proximal end portion 112 of the tubular handle 11 and an inner wall of the mounting socket 33 of the thumper head 30 so as to further enhance the engagement of the thumper head 30 and the tubular handle 11.

Referring to FIG. 6 to FIG. 9, the retractor joint assembly 40 comprises a connector member 41 having a through hole 411 having a diameter equal to or slightly larger than an outer diameter of the solid bar 12, a sliding stud 42 having a predetermined axial length and an outer diameter equal to or slight smaller than an inner diameter of the tubular handle 11, and first and second sealing rings 43, 44.

The tubular handle 11 has an inner enlarged threaded slot 113 at a distal end thereof. The connector member 41 comprises a joint head 412 having an outer diameter equals to an outer diameter of the tubular handle 11 and a threaded connector 413 integrally extended from the joint head 412 and configured to be screwingly connected to the inner enlarged threaded slot 113 provided in the portion of the through hole 411 extending through the joint head 412 of the tubular handle 11.

The first sealing ring 43 is mounted to an inner surface of the through hole 411 of the joint head 41 so that the solid bar 12 penetrating through the through hole 411 of the connector member 41 can be sealingly and smoothly sliding therebetween coaxially and the second sealing ring 44 is mounted to an outer surface of the sliding stud 42 so that the sliding stud 42 can be sealing and smoothly sliding along the tubular handle 11 coaxially.

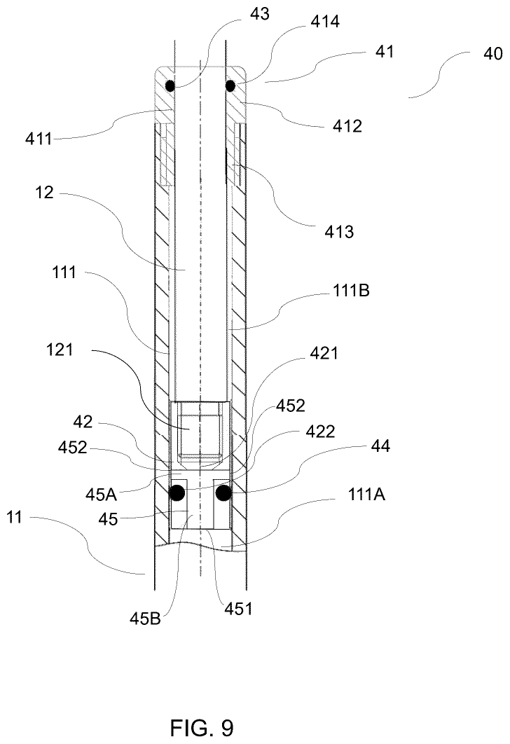

According to the preferred embodiment, the connector member 41 further has a first ring groove 414 indented near one end of the through hole 411, which is configured to fittingly receive the first sealing ring 43 therein. The first ring groove 414 is shaped corresponding to the first sealing ring 43 and has a depth slightly smaller than a sectional size of the first sealing ring 43, so that when the first sealing ring 43 is situated in the first ring groove 411, an inner edge of the first sealing ring 43 is protruding inwardly and pressing against the solid bar 12 penetrating through the connector member 41, as shown in FIG. 8 and FIG. 9.

In order to ensure the rigid and secure connection between the tubular handle 11 and the solid bar 12, the sliding of the solid bar 12 with respect to the connector member 41 is an air-tight manner by means of the first sealing ring 43 and the sliding stud 42 sliding forth and back along the receiving channel 111 in a sealing manner as mentioned above by means of the second sealing ring 44. It is preferred to have no air hole formed along the tubular handle 11 but one air flow problem is required to be solved, i.e. the air within the receiving channel 111. In order to allow the sliding stud 42 sliding along the receiving channel 111, the portion of air contained between the thumper head 30 and the sliding stud 41 in the receiving channel 111 and the portion of air contained between the sliding stud 41 and the connector member 41 in the receiving channel 111 must be arranged communicating with outside or with each other.

The sliding stud 42 is integrally connected, such as screwing, to a threaded connecting end 121 of the solid bar 12 coaxially. In particular, the sliding stud 42 has a threaded hole 421 configured for the connecting end 121 of the solid bar 12 to screw therein coaxially.

A diameter of the sliding stud 42 is larger than the solid bar 12, smaller than the diameter of the through hole 411 of the connector member 41, and equal to or slightly smaller than the diameter of the receiving channel 111 of the tubular handle such that the sliding stud 42 is able to be sliding along the receiving channel 111. The sliding stud 42 further has a second ring groove 422 indented therearound and configured to have a size and a shape for the second sealing ring 44 to be situated therein while having an outer edge of the second sealing ring 44 protruding out for slightly pressing against the inner wall of the receiving channel 111 while the sliding stud 42 is sliding along the receiving channel 111. Accordingly, referring to FIG. 8, a stopper shoulder 415 is formed at a bottom surface of the connector member 41 with respect to a top surface of the sliding stud 42 to restrict the extending movement of the solid bar 12 when the top surface of the sliding stud 42 is stopped by the stopper shoulder 415.

To assemble the retractor joint assembly 40 to connect the solid bar 12 with the tubular handle 10 in an extendable and retractable manner, allowing the solid bar 12 to slide coaxially along the tubular handle 11, as shown in FIG. 6, FIG. 8 and FIG. 9, penetrate the solid bar 12 through the through hole 411 of the connector member 41, wherein the first sealing ring 42 slightly presses against an outer wall of the solid bar 12 to ensure a slidable tight contact between the solid bar 12 and the connector member 41 while the solid bar 12 is smoothly sliding through the connector member 41; connect the sliding stud 42 to the connecting end 121 of the solid bar 12 by screwing the connecting end 121 with the threaded hole 421 of the sliding stud 42; insert the solid bar 12 with the sliding stud 42 connected thereto into the receiving channel 111 of the tubular handle 11, wherein the second sealing ring 44 slightly presses against an inner wall of the receiving channel 111 of the tubular handle 11 to ensure a slidable tight contact while the sliding stud 42 is smoothly sliding in the tubular handle 11; and then connect the connector member 41 to the distal end of the tubular handle 11 by screwing the threaded connector 413 of the connector member 41 into the threaded slot 113 of the tubular handle 11.

Accordingly, the sliding stud 42 can be slid smoothly between the thumper head 30 of the utility tool and the connector member 41 connected to the distal end of the tubular handle 11 within the receiving channel 111. When the sliding stud 42 slides to the proximal end of the tubular handle 11, the handle bar 10 is in the retract state that a length of the solid bar 12, approximately equal to the length of the receiving channel 111, is received in the receiving channel 111, as shown in FIG. 7, allowing the utility tool to function as the tire thumper and the glass breaker as shown in FIG. 3. When the sliding stud 42 slides to the connector member 41, as shown in FIG. 8, the handle bar 10 is in the extend state that the solid bar 12 is fully extended out to lengthen the handle bar 10, allowing the utility tool to function as the fifth wheel pin puller as shown in FIG. 4.

It is appreciated that the length of the connector member 41 is preferred to be at least equal to the diameter of the tubular handle 11 and the length of the sliding stud 42 is preferred to be double greater than the diameter of the tubular handle 11, such that when the solid bar 12 is fully extended from the tubular handle in the extend state, the solid bar 12 is maintained coaxially with the tubular handle 11 due to a flexural resistance provided by an overlapping length L, as shown in FIG. 4, equal to a total length of the connector member 41 and the sliding stud 42.

Referring to FIG. 6 to FIG. 9, according to the preferred embodiment, the retractor joint assembly 40 further has an air channel 45 formed in the sliding stud 42, extending from an end opening 451 of the air channel 45, coaxially formed at an end of the sliding stud 42, to at least one side opening 452 of the air channel 45, radially formed at one side surface of the sliding stud 42 while the second sealing ring 44 is mounted on the outer surface of the sliding stud 42 and positioned between the end opening 451 and the side opening 452.

According to the preferred embodiment, as shown in FIG. 6, the air channel 45 is a T-shape channel having a radial hole 45A extended between two opposing side surfaces of the sliding stud 42 to form two side openings 452 and an axial hole 45B extended from the radial hole 45A to the end opening 451.

Accordingly, referring to FIG. 7 to FIG. 9, the sliding stud 42 of the retractor joint assembly 40 is capable of smoothly sliding along the receiving channel 111 in an air-tight manner and divides the receiving channel 111 into a first section 111A between the sliding stud 42 and the thumper head 30 and a second section 111B between the sliding stud 42 and the joint head 41, wherein the first section 111A and the second section 111B of the receiving channel 111 are sealingly isolated by the second sealing ring 44 mounted on the sliding stud 42 and communicating through the air channel 45. In order words, the second sealing ring 44 is positioned between the first section 111A and the second section 111B of the receiving channel 111.

Thereby, when the sliding stud 42 slides towards the thumper head 30, as shown in FIG. 7 and FIG. 9, the air in the first section 111A of the receiving channel 111 flows into the second section 111B of the receiving channel 111 via the air channel 45, and when the sliding stud 42 slides towards the joint head 41, as shown in FIG. 8 and FIG. 9, the air in the second section 111B of the receiving channel 111 flows into the first section 111A of the receiving channel 111 via the air channel 45.

Per each transportation trip, a truck driver has to detach the trailer from the tractor by pulling out the fifth wheel locking pin and check all the tires before another transportation trip. The utility tool of the present invention is specifically designed for the driver to accomplish the above two necessary jobs with the same tool while the utility tool can also function as a glass breaker when it is not in use and keep in place in the cabin of the tractor by simply magnetically attract to a metal surface, wherein the utility tool is retracted in the retract state to reduce its length and overall size.

When the utility tool functions as the tire thumper and glass breaker, the solid bar 12 is retracted in the tubular handle 11, as shown in FIG. 3 and FIG. 7. Since the outer diameter of the solid bar 12 is slightly smaller than the inner diameter of the receiving channel 111, when the solid bar 12 is coaxially received in the receiving channel 111, the handle bar 10 becomes a solid rod with a total weight of the tubular handle 11 and the solid bar 12, that is adapted to function as handle for the driver to hold and operate the thumper head 30 to impact on the truck tire as a tire thumper or the windshield or window of the truck as a glass breaker for emergency exit.

For fifth wheel pin puller, it is essential to provide an axial pulling force. Therefore, when the utility tool functions the fifth wheel pin puller, the retractor joint assembly 40 is specifically designed to have the predetermined total overlapping length L that significantly provides a lengthened rigid connection between the tubular handle 11 and the solid bar 12 in the extend state, as shown in FIG. 4 and FIG. 8, so as to ensure a strengthen extension of the handle bar 10 and a straight alignment along the same axis of the tubular handle 11 and the solid bar 12.

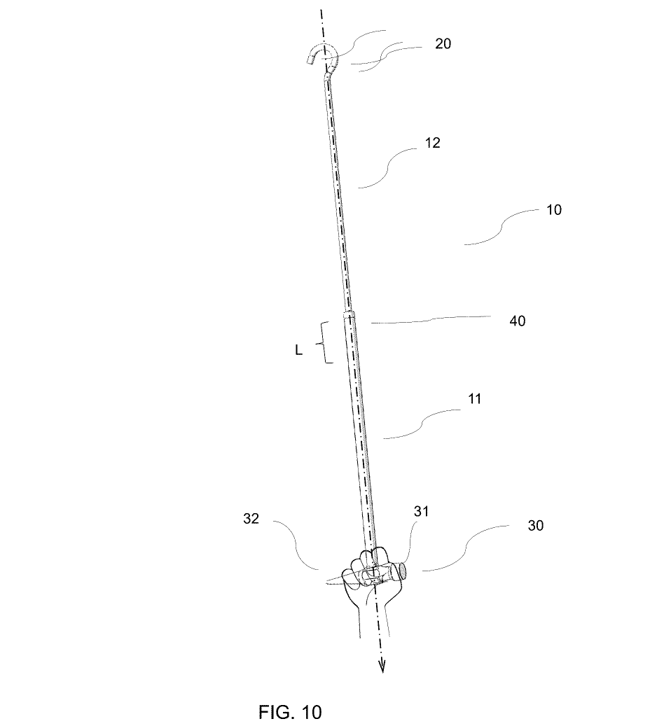

In addition, referring to FIG. 4 and FIG. 10, in order to ensure a straight alignment of the handle bar 10 and the hook element 20, the hook element 20 is preferably curved on the same plane of the hammer portion 31 and glass breaker portion 32 of the thumper head 30. The conical taper shape and the size of the glass breaker portion 32 is generally designed to fit the space between the middle finger, the ring finger and the pinky finger with palm of the driver's hand, ensuring the driver's index, ring and pinky fingers and his or her palm to hold on the glass breaker portion 32 while the index finger and the thumb of the driver comfortably rests around the ring groove 311 of the hammer portion 31. In other words, the ergonomic configuration of the thumper head 30 is designed to adapt to the natural grip curvature of the driver's hand, allow for a secure grip with minimal effort, and reduce the risk of slipping while providing a reliable point for exerting force and the entire hand of the driver fittingly grip on the thumper head 30 without clearance.

As shown in FIG. 10, when a hand holds a fist, the shape of a human hand, including the ring finger is shorter than the middle finger and the pinky finger is shorter than the ring finger, the taper shape of the glass breaker portion 32 is ergonomically advantageous to conform the natural shape of the hand and accommodate the varying lengths and positions of the fingers. The taper glass breaker portion 32 gradually narrows towards the breaking point 321, matching the decreasing lengths of the fingers and the alignment ensures that each finger can comfortably rest on the thumper head 30 without excessive stretching or compression by the driver's hand that substantially helps the driver to securely and comfortably hold on the thumper head 30 while applying a pulling force along the axis of the handle bar 10. The wider hammer portion 31 provides a stable grip for the thumb and the index finger of the driver, especially the ring groove 311 ensures the preferred alignment and positioning of the hand with respect to the thumper head 30 with anti-slip purpose. At the same time, the narrowing taper shape of the glass breaker portion 32 fits snugly under the middle, ring and pinky fingers, supporting the weaker fingers in maintaining a firm hold and preventing slipping.

It is appreciated that, the configuration and shape of the thumper head 30 not only accommodates different hand sizes, but also distributes the gripping force evenly across the hand, avoiding concentrated pressure on specific areas that could cause discomfort or strain during use. The slant outer taper surface of the glass breaker portion 32 fits to the slant space defined between the fingers with different lengths and the palm of the driver's hand as well as the balance weights of the hammer portion 31 and the glass breaker portion 32, as shown in FIG. 10, that significantly aligns the extended handle bar 10 with the arm of the driver to promote the arm and hand of the driver to efficiently exert the pulling force to the hook element 20 through the thumper head 30 and the handle bar 10, so as to allow the driver to apply precise force and maintain better control of the utility tool.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A utility tool for truck, comprising:
a handle bar comprising a tubular handle having an axial receiving channel defined therein and an elongated solid bar having a length longer than that of said tubular handle and a diameter slightly smaller than a diameter of said receiving channel;
a hook element integrally provided at a distal end of said solid bar of said handle bar;
a thumper head comprising a hammer portion configured to function as a hammer and a glass breaker portion configured to function as a glass breaker, wherein a proximal end of said tubular handle of said handle bar is firmly and securely connected to a position between said hammer portion and said glass breaker portion such that said handle bar is perpendicularly extended from said thumper head; and
a retractor joint assembly configured to rigidly and securely connect said tubular handle and said solid bar in an extendable and retractable manner, wherein when said solid bar is extended form said tubular handle of said handle bar in an extend state, said utility tool is capable of functioning as a fifth wheel pin puller, and that when said solid bar is retracted in said tubular handle in a retract state, said solid bar is ensured to be coaxially received in said receiving channel in a rigid and firm manner to form an ergonomic handle while said utility tool is used as a tire thumper with said hammer portion and a glass breaker with said glass breaker portion of said thumper head, wherein during the extend state, said connector member, said connecting end of said solid bar and said sliding stud together provide an overlapping length to strengthen a connection of said tubular handle and said solid bar and ensure an alignment of said tubular handle and said solid bar coaxially.

2. The utility tool, as recited in claim 1, wherein a middle connection portion, positioned between said hammer portion and said glass breaker portion, of said thumper head has a mounting socket perpendicularly formed therein, wherein said proximal end of said tubular handle is fittingly inserted into said mounting socket perpendicularly in a rigid and firm manner so as to integrally connected said tubular handle of said handle bar with said thumper head in a perpendicular manner, such that said hammer portion and said glass breaker portion of said thumper head are extended at two opposing sides of said tubular handle, wherein a center of gravity of said thumper head is positioned at said middle connection portion.

3. The utility tool, as recited in claim 2, wherein said glass breaker portion is configured to have a taper shape, reducing a size gradually from said middle connection portion to a free end to form a breaker point adapted for impacting onto a glass surface to break the glass.

4. The utility tool, as recited in claim 3, wherein said hammer portion of said thumper head has a ring groove circularly indented between a front end portion thereof and said middle connection portion, wherein said ring groove has curvature configured to conform a curvature of an index finger for guiding a hand of a driver to properly hold on said thumper head in a balance and effective manner through allowing the index finger to place fittingly therein.

5. The utility tool, as recited in claim 3, wherein a weight of said hammer portion is equal to a weight of said glass breaker portion.

6. The utility tool, as recited in claim 4, wherein a weight of said hammer portion is equal to a weight of said glass breaker portion.

7. The utility tool, as recited in claim 1, wherein said retractor joint assembly comprises a connector member having a through hole having a diameter equal to or slightly larger than an outer diameter of said solid bar, and a sliding stud having a predetermined axial length and an outer diameter equal to or slight smaller than an inner diameter of said tubular handle, wherein said tubular handle has an inner enlarged threaded slot at a distal end thereof, wherein said connector member comprises a joint head having an outer diameter equals to an outer diameter of said tubular handle and a threaded connector integrally extended from said joint head and configured to be connected to said inner threaded slot provided in a portion of said through hole extending through said joint head of said tubular handle.

8. The utility tool, as recited in claim 7, wherein said sliding stud integrally connected to a connecting end of the solid bar coaxially, wherein a diameter of said sliding stud is larger than said solid bar, smaller than a diameter of said through hole of said connector member, and equal to or slightly smaller than a diameter of said receiving channel of said tubular handle such that said sliding stud is able to be sliding along said receiving channel, wherein a stopper shoulder is formed at a bottom surface of said connector member with respect to a top surface of said sliding stud to restrict an extending movement of said solid bar when the top surface of said sliding stud is stopped by said stopper shoulder, wherein a length of said connector member is at least equal to a diameter of said tubular handle and a length of said sliding stub is at least double greater than the diameter of said tubular handle.

9. The utility tool, as recited in claim 8, wherein said retractor joint assembly further comprises first and second sealing rings, wherein said connector member has a first ring groove indented near one end of the through hole and configured to fittingly receive said first sealing ring therein, wherein said first ring groove is shaped corresponding to said first sealing ring and has a depth slightly smaller than a sectional size of said first sealing ring, so that when said first sealing ring is situated in said first ring groove, an inner edge of said first sealing ring is protruding inwardly and pressing against said solid bar penetrating through said connector member, wherein said stud has a second ring groove indented therearound and configured to have a size and a shape for said second sealing ring to be situated therein while having an outer edge of said second sealing ring protruding out for slightly pressing against an inner wall of the receiving channel while said sliding stud is sliding along said receiving channel in a such a manner that said first sealing ring slightly presses against an outer wall of said solid bar to ensure a slidable tight contact between said solid bar and said connector member while said solid bar is smoothly sliding through said connector member, wherein said sliding stud is connected to said connecting end of said solid bar and is inserted in said received channel with said solid bar in such a manner that said second sealing ring slightly presses against an inner wall of said receiving channel of said tubular handle to ensure a slidable tight contact while said sliding stud is smoothly sliding in said tubular handle.

10. The utility tool, as recited in claim 4, wherein said retractor joint assembly comprises a connector member having a through hole having a diameter equal to or slightly larger than an outer diameter of said solid bar, and a sliding stud having a predetermined axial length and an outer diameter equal to or slight smaller than an inner diameter of said tubular handle, wherein said tubular handle has an inner enlarged threaded slot at a distal end thereof, wherein said connector member comprises a joint head having an outer diameter equals to an outer diameter of said tubular handle and a threaded connector integrally extended from said joint head and configured to be connected to said inner threaded slot provided in a portion of said through hole extending through said joint head of said tubular handle.

11. The utility tool, as recited in claim 10, wherein said sliding stud integrally connected to a connecting end of the solid bar coaxially, wherein a diameter of said sliding stud is larger than said solid bar, smaller than a diameter of said through hole of said connector member, and equal to or slightly smaller than a diameter of said receiving channel of said tubular handle such that said sliding stud is able to be sliding along said receiving channel, wherein a stopper shoulder is formed at a bottom surface of said connector member with respect to a top surface of said sliding stud to restrict an extending movement of said solid bar when the top surface of said sliding stud is stopped by said stopper shoulder, wherein a length of said connector member is at least equal to a diameter of said tubular handle and a length of said sliding stub is at least double greater than the diameter of said tubular handle.

12. The utility tool, as recited in claim 11, wherein said retractor joint assembly further comprises first and second sealing rings, wherein said connector member has a first ring groove indented near one end of the through hole and configured to fittingly receive said first sealing ring therein, wherein said first ring groove is shaped corresponding to said first sealing ring and has a depth slightly smaller than a sectional size of said first sealing ring, so that when said first sealing ring is situated in said first ring groove, an inner edge of said first sealing ring is protruding inwardly and pressing against said solid bar penetrating through said connector member, wherein said stud has a second ring groove indented therearound and configured to have a size and a shape for said second sealing ring to be situated therein while having an outer edge of said second sealing ring protruding out for slightly pressing against an inner wall of the receiving channel while said sliding stud is sliding along said receiving channel in a such a manner that said first sealing ring slightly presses against an outer wall of said solid bar to ensure a slidable tight contact between said solid bar and said connector member while said solid bar is smoothly sliding through said connector member, wherein said sliding stud is connected to said connecting end of said solid bar and is inserted in said received channel with said solid bar in such a manner that said second sealing ring slightly presses against an inner wall of said receiving channel of said tubular handle to ensure a slidable tight contact while said sliding stud is smoothly sliding in said tubular handle.

13. The utility tool, as recited in claim 6, wherein said retractor joint assembly comprises a connector member having a through hole having a diameter equal to or slightly larger than an outer diameter of said solid bar, and a sliding stud having a predetermined axial length and an outer diameter equal to or slight smaller than an inner diameter of said tubular handle, wherein said tubular handle has an inner enlarged threaded slot at a distal end thereof, wherein said connector member comprises a joint head having an outer diameter equals to an outer diameter of said tubular handle and a threaded connector integrally extended from said joint head and configured to be connected to said inner threaded slot provided in a portion of said through hole extending through said joint head of said tubular handle.

14. The utility tool, as recited in claim 13, wherein said sliding stud integrally connected to a connecting end of the solid bar coaxially, wherein a diameter of said sliding stud is larger than said solid bar, smaller than a diameter of said through hole of said connector member, and equal to or slightly smaller than a diameter of said receiving channel of said tubular handle such that said sliding stud is able to be sliding along said receiving channel, wherein a stopper shoulder is formed at a bottom surface of said connector member with respect to a top surface of said sliding stud to restrict an extending movement of said solid bar when the top surface of said sliding stud is stopped by said stopper shoulder, wherein a length of said connector member is at least equal to a diameter of said tubular handle and a length of said sliding stub is at least double greater than the diameter of said tubular handle.

15. The utility tool, as recited in claim 14, wherein said retractor joint assembly further comprises first and second sealing rings, wherein said connector member has a first ring groove indented near one end of the through hole and configured to fittingly receive said first sealing ring therein, wherein said first ring groove is shaped corresponding to said first sealing ring and has a depth slightly smaller than a sectional size of said first sealing ring, so that when said first sealing ring is situated in said first ring groove, an inner edge of said first sealing ring is protruding inwardly and pressing against said solid bar penetrating through said connector member, wherein said stud has a second ring groove indented therearound and configured to have a size and a shape for said second sealing ring to be situated therein while having an outer edge of said second sealing ring protruding out for slightly pressing against an inner wall of the receiving channel while said sliding stud is sliding along said receiving channel in a such a manner that said first sealing ring slightly presses against an outer wall of said solid bar to ensure a slidable tight contact between said solid bar and said connector member while said solid bar is smoothly sliding through said connector member, wherein said sliding stud is connected to said connecting end of said solid bar and is inserted in said received channel with said solid bar in such a manner that said second sealing ring slightly presses against an inner wall of said receiving channel of said tubular handle to ensure a slidable tight contact while said sliding stud is smoothly sliding in said tubular handle.

16. The utility tool, as recited in claim 1, further comprising a magnetic member which is inserted into a bottom end of said mounting socket, wherein said proximal end of said tubular handle is fittingly inserted into said mounting socket until pressing against said magnetic member in a rigid and firm manner, such that said thumper head is configured to be a magnetic attractable body that allows the utility tool to attach on a metallic surface by magnetically attracting said middle connection portion thumper head to the metallic surface.

17. The utility tool, as recited in claim 15, further comprising a magnetic member which is inserted into a bottom end of said mounting socket, wherein said proximal end of said tubular handle is fittingly inserted into said mounting socket until pressing against said magnetic member in a rigid and firm manner, such that said thumper head is configured to be a magnetic attractable body that allows the utility tool to attach on a metallic surface by magnetically attracting said middle connection portion thumper head to the metallic surface.

18. The utility tool, as recited in claim 9, wherein said retractor joint assembly further has an air channel formed in said sliding stud, extending from an end opening of said air channel, coaxially formed at an end of said sliding stud, to at least one side opening of said air channel, radially formed at one side surface of said sliding stud while said sealing ring mounted on said sliding stud is positioned between said end opening and said side opening, such that said sliding stud is capable of smoothly sliding along said receiving channel in an air-tight manner and divides said receiving channel into a first section between said sliding stud and said thumper head and a second section between said sliding stud and said joint head, wherein said first section and said second section of said receiving channel are sealingly isolated by said sealing ring mounted on said sliding stud and communicating through said air channel, such that when said sliding stud slides towards said thumper head, the air in said first section of said receiving channel flows into said second section of said receiving channel via said air channel, and when said sliding stud slides towards said joint head, the air in said second section of said receiving channel flows into said first section of said receiving channel via said air channel.

19. The utility tool, as recited in claim 12, wherein said retractor joint assembly further has an air channel formed in said sliding stud, extending from an end opening of said air channel, coaxially formed at an end of said sliding stud, to at least one side opening of said air channel, radially formed at one side surface of said sliding stud while said sealing ring mounted on said sliding stud is positioned between said end opening and said side opening, such that said sliding stud is capable of smoothly sliding along said receiving channel in an air-tight manner and divides said receiving channel into a first section between said sliding stud and said thumper head and a second section between said sliding stud and said joint head, wherein said first section and said second section of said receiving channel are sealingly isolated by said sealing ring mounted on said sliding stud and communicating through said air channel, such that when said sliding stud slides towards said thumper head, the air in said first section of said receiving channel flows into said second section of said receiving channel via said air channel, and when said sliding stud slides towards said joint head, the air in said second section of said receiving channel flows into said first section of said receiving channel via said air channel.

20. The utility tool, as recited in claim 15, wherein said retractor joint assembly further has an air channel formed in said sliding stud, extending from an end opening of said air channel, coaxially formed at an end of said sliding stud, to at least one side opening of said air channel, radially formed at one side surface of said sliding stud while said sealing ring mounted on said sliding stud is positioned between said end opening and said side opening, such that said sliding stud is capable of smoothly sliding along said receiving channel in an air-tight manner and divides said receiving channel into a first section between said sliding stud and said thumper head and a second section between said sliding stud and said joint head, wherein said first section and said second section of said receiving channel are sealingly isolated by said sealing ring mounted on said sliding stud and communicating through said air channel, such that when said sliding stud slides towards said thumper head, the air in said first section of said receiving channel flows into said second section of said receiving channel via said air channel, and when said sliding stud slides towards said joint head, the air in said second section of said receiving channel flows into said first section of said receiving channel via said air channel.
